(19) United States
(12) Patent Application Publication
(10) Pub. No.: US 2014/0006218 A1
(43) Pub. Date: Jan. 2, 2014

(54) Systems and Methods for a Merchant to Accept Telephone Orders and Process Payments

(71) Applicant: Arunachalam Muthu, Fremont, CA (US)

(72) Inventor: Arunachalam Muthu, Fremont, CA (US)

(73) Assignee: eBay, Inc., San Jose, CA (US)

(21) Appl. No.: 13/535,704

(22) Filed: Jun. 28, 2012

(51) Int. Cl. G06Q 30/06

(52) U.S. Cl. 705/26.82; 705/26.8

(57) ABSTRACT

Systems and methods are disclosed to enable a merchant to sell products through a merchant-specific toll-free number operated by a payment service provider. The toll-free number may operate using an interactive voice response system to accept product orders and to process payments without requiring a consumer to enter information on the payment source. A consumer who has a registered account with the payment service provider may call the merchant toll-free number to purchase products using product codes that are keyed to the products. The payment service provider may identify the consumer and the consumer's registered account from the phone number used by the consumer in making the call. The payment for the purchase may be made from the consumer's account to the merchant's account. Information on the purchase and on the consumer including a shipping address is transmitted to the merchant to enable the merchant to fulfill the order.

### TECHNICAL FIELD

The present disclosure relates generally to electronic commerce. In particular, the present disclosure presents systems and methods for merchants to accept telephone orders from buyers and to process payments through a payment service provider.

### BACKGROUND

Consumers may make purchases on-line or in-store, and may make payments for the purchases using their credit cards, debit cards, or accounts with a payment service provider. However, to provide the convenience of electronic commerce to the consumers, merchants may incur significant up-front costs. For example, to sell products on-line, merchants may need to establish and maintain a website to accept on-line orders. For in-store sales, merchants may need one or more point-of-sale (POS) terminals linked to a payment processor to process payments. Often, small merchants may not have the resources to establish a website, to operate a physical store, or to acquire POS terminals. As such, small merchants may resort to other types of sale channels requiring less up-front expenditures, but these sale channels often are not convenient for consumers or may raise security concerns. For example, merchants may take orders over the telephone, but it may be cumbersome and time-consuming for consumers to specify products and provide payment information over the telephone. In addition, consumers may be unwilling to provide payment information such as a credit card number over the telephone for fear of the unauthorized use of the credit card number. Accordingly, there is a need to enable consumers and merchants to conduct electronic commerce simply, cost-effectively, and securely.

### BRIEF DESCRIPTION OF THE DRAWINGS

FIG. 1 shows a consumer calling a merchant toll-free number operated by a payment service provider from the consumer's mobile phone to make purchases from the merchant according to one or more embodiments of the present disclosure;

FIG. 2 shows a flow chart illustrating a method for a merchant to establish a toll-free number with a payment service provider and to configure the toll-free number to sell products identified by product codes according to one or more embodiments of the present disclosure;

FIG. 3 shows a flow chart illustrating a method for a payment service provider to accept orders for products from a consumer over a merchant toll-free number and to process a payment according to one or more embodiments of the present disclosure; and

FIG. 4 is a block diagram of a computer system suitable for implementing one or more components discussed herein according to one embodiment of the present disclosure.

Embodiments of the present disclosure and their advantages are best understood by referring to the detailed description that follows. It should be appreciated that like reference numerals are used to identify like elements illustrated in one or more of the figures.

### DETAILED DESCRIPTION

Systems and methods are disclosed herein to enable a merchant to sell products through a merchant-specific toll-free number operated by a payment service provider. The payment service provider may operate the toll-free number using an interactive voice response system to accept orders for product purchases and may process payments for the purchases without requiring a consumer to enter sensitive payment information. The merchant may establish and configure the toll-free number to sell products that are identified by product codes. A consumer who has a registered account with the payment service provider may call the merchant toll-free number to purchase products using the product codes. The payment service provider may identify the consumer and the consumer's registered account from the phone number used by the consumer in making the call. The payment service provider may further identify the merchant from the merchant toll-free number. After the consumer completes the purchase and authorizes a payment for the purchase, the payment service provider may transfer the payment from the consumer's account to the merchant's account. The payment service provider may transmit information on the purchase and information concerning the consumer, such as the consumer's name and shipping address, to the merchant to enable the merchant to fulfill the order. Thus, the consumer enjoys an expedited and secure product purchasing experience over the phone. The merchant also enjoys the advantage of not having to expend resources to establish a website or a store to sell products.

In accordance with one or more embodiments of the present disclosure, an apparatus of a payment service provider is disclosed. The apparatus includes one or more processors. The apparatus also includes a memory that stores machine-readable instructions for execution by the processors to receive a call from a user to a number used by a merchant to sell products. The user has a registered account with the payment service provider and the registered account is associated with a communication device used by the user in making the call. The apparatus also receives an identifier of the communication device as a part of the call. The apparatus further identifies the user and the registered account from the identifier of the communication device. The apparatus further accepts an order for products from the communication device. The apparatus further transfers a payment for the order from the registered account of the user to an account of the merchant without requiring the user to identify a payment source. The apparatus further transmits a message to the merchant for the merchant to fulfill the order.

In accordance with one or more embodiments of the present disclosure, a method of selling products by a payment service provider for a merchant is disclosed. The method includes receiving a call from a user to a number used by a merchant to sell products. The user has a registered account with the payment service provider and the registered account is associated with a communication device used by the user in making the call. The method also includes receiving an identifier of the communication device as a part of the call. The method further includes identifying the user and the registered account of the user from the identifier of the communication device. The method further includes accepting an order for products from the communication device. The method further includes transferring a payment for the order from the registered account of the user to an account of the merchant without requiring the user to identify a payment source. The method further includes transmitting a message to the merchant for the merchant to fulfill the order.

In accordance with one or more embodiments of the present disclosure, a non-transitory computer readable medium having machine readable instructions for execution by one or more processors of a device to perforin a method is disclosed. The method includes receiving a call from a user to a number used by a merchant to sell products. The user has a registered account with the payment service provider and the registered account is associated with a communication device used by the user in making the call. The method also includes receiving an identifier of the communication device as a part of the call. The method further includes identifying the user and the registered account of the user from the identifier of the communication device. The method further includes accepting an order for products from the communication device. The method further includes transferring a payment for the order from the registered account of the user to an account of the merchant without requiring the user to identify a payment source. The method further includes transmitting a message to the merchant for the merchant to fulfill the order.

These and other embodiments of the present disclosure will be more fully understood by reference to the following detailed description of the embodiments when considered in conjunction with the accompanying drawings.

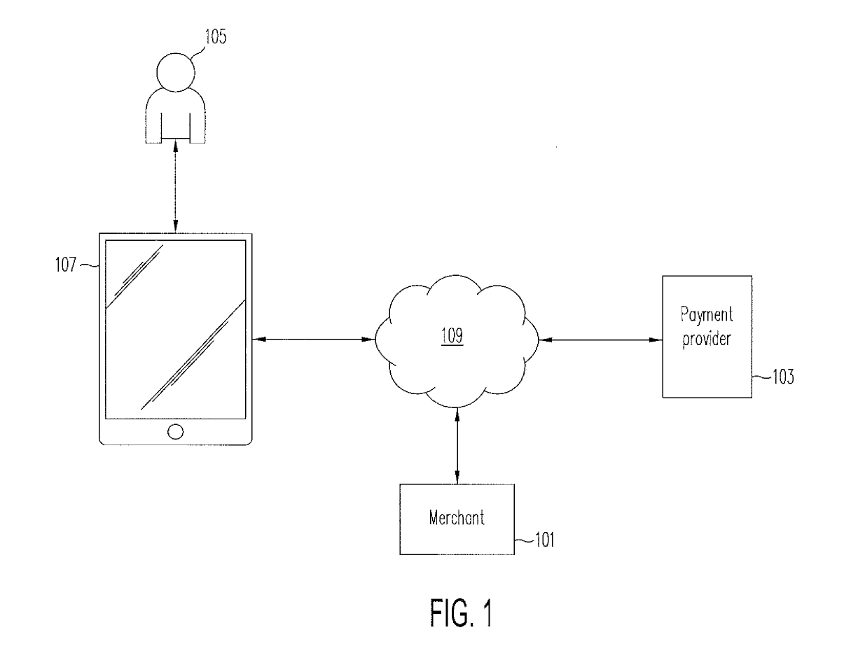

Refer now to the figures wherein the drawings are for purposes of illustrating embodiments of the present disclosure only, and not for purposes of limiting the same. FIG. 1 shows a consumer calling a merchant toll-free number operated by a payment service provider from the consumer's mobile phone to make purchases from the merchant according to one or more embodiments of the present disclosure.

A merchant 101 signs up with a payment service provider 103 to register an account and to establish a merchant toll-free number to sell products over the phone. Payment service provider 103 may be PayPal of San Jose, Calif. The registered account is used by merchant 101 to deposit proceeds from the sales and may also be used to issue refunds or credits. Merchant 101 may link a bank account and/or a credit card number to provide a funding source for the registered account or to receive disbursements from the registered account. The toll-free number is unique to the merchant and provides an interactive response system to accept product orders. To expedite product purchases over the toll-free number, each product may be keyed to a product code. During the initial set up, merchant 101 may configure the interactive response system to set up a product catalogue to include the product codes and the prices of the products in the merchant's inventory. After the initial set up, merchant 101 may update the product catalogue to add product codes and prices of new products or to remove the product codes of products that are out of stock.

In one or more embodiments, payment service provider 103 may manage the product inventory in conjunction with merchant 101 and may update the product catalogue as products become out of stock. For example, merchant 101 during the initial set up or subsequent updates may specify the number of items merchant 101 has in stock for each product on the product catalogue. As products are sold over the merchant toll-free number, payment service provider 103 may keep track of the number of items in stock for the products. When the inventory for a product is depleted, payment service provider 103 may remove the product from the product catalogue and may also alert merchant 101 to replenish the product inventory. After merchant 101 replenishes the inventory for the product, merchant 101 may update the product catalogue to re-list the product and to update the number of items in stock. In one or more embodiments, merchant 101 may configure and/or update the product catalogue through a webpage provided by payment service provider 103 for merchant 101 to manage its inventory. In other embodiments, the toll-free number may have a menu providing privileged access for merchant 101 to manage the inventory. Payment service provider 103 may implement the toll-free number and the services to accept orders, manage inventories, and process payments on a computer having one or more processors, memories, communication components, etc. One skilled in the art would understand that the processors of payment service provider 103 may run applications residing in the memories to provide services pertinent to the toll-free number to merchant 101 and buyers.

Merchant 101 may advertise products along with the product codes for the products. The advertisement may direct buyers to call the merchant toll-free and to use the product codes to specify the products to purchase. Consumer 105, who has a registered account with payment service provider 103, calls the merchant toll-free number using a mobile device 107 through a network 109. Mobile device 107 may be a smart phone (e.g., iPhone, or other phones running Android, Window Mobile, or other operating systems), a PDA, a tablet computer, or other types of mobile communication devices. Payment service provider 103 may identify consumer 105 and the registered account from a unique identifier of mobile device 107 such as its phone number or IP address because the unique identifier was provided by consumer 105 during account registration to associate mobile device 107 with the registered account of consumer 105. In one or more embodiments, consumer 105 may call the merchant toll-free number using landline phones, computers running voice-over-IP, or other types of wired or wireless communication devices as long as the unique identifier of the communication device is associated with the registered account to enable payment service provider 103 to identify consumer 105 from the unique identifier. In various embodiments, the network may include the Internet, intranets, wireless communication networks (e.g., cellular phone networks, Bluetooth, LAN, WiFi, WiMax, etc.), landline networks, and/or other appropriate types of communication networks.

After identifying consumer 105, the interactive voice response system of the toll-free number may issue a personalized greeting message to consumer 105 and may prompt consumer 105 to enter the product code of the product to purchase. Consumer 105 may enter the product code and the quantity of the desired product. Alternatively, consumer 105 may query the interactive voice response system for the product code. For example, consumer 105 may command the interactive voice response system to scroll through the product catalogue to provide the product codes and the names of products. In one or more embodiments, the interactive voice response system may group the products by categories to make it easier for consumer 105 to navigate through the product catalogue. For example, the interactive voice system may initially present the product categories with their corresponding category codes and may instruct consumer 105 to select a category code for a product category to listen to the product codes and the names of products under that product category. Consumer 105 may enter product codes or category codes using keypads, icons on a touch-screen, or voice commands. In one or other embodiments, the voice response system may employ voice recognition technology to detect product codes spoken by consumer 105. In other embodiments, the voice recognition technology may recognize products from the names of the products spoken by consumer 105 without requiring consumer 105 to provide the product codes.

Payment service provider 103 may verify that the product code entered by consumer 105 corresponds to a product on the product catalogue. In one or more embodiments when payment service provider 103 assists in tracking product inventory, payment service provider 103 may further verify if the product is in stock. If consumer 105 enters a non-valid product code or if the product corresponding to a valid product code is out of stock, the interactive voice response system may ask consumer 105 to make another selection. After consumer makes a selection for a product in stock, the interactive voice response system may ask consumer 105 to confirm the selection and may ask if consumer 105 wishes to purchase another product. Consumer 105 may enter the product codes and the quantities for additional products until consumer 105 finishes shopping and is ready to check out.

Payment service provider 103 may generate a total price for the products purchased including taxes and shipping and may request consumer 105 to confirm the order and to authorize a payment from the registered account of consumer 105. After consumer 105 confirms the order and authorizes the payment, payment service provider 103 may transfer the payment for the purchase from the registered account of consumer 105 to the account of merchant 101. Payment service provider 103 may obtain additional information of consumer 105 from the registered account such as a shipping address of consumer 105. Payment servicer provider 103 may transmit to merchant 101 through network 109 order information such as the product codes, quantities of products purchased, total sale price, shipping method, name and address of customer 105, etc. Merchant 101 may fulfill the order by shipping the products to customer 105.

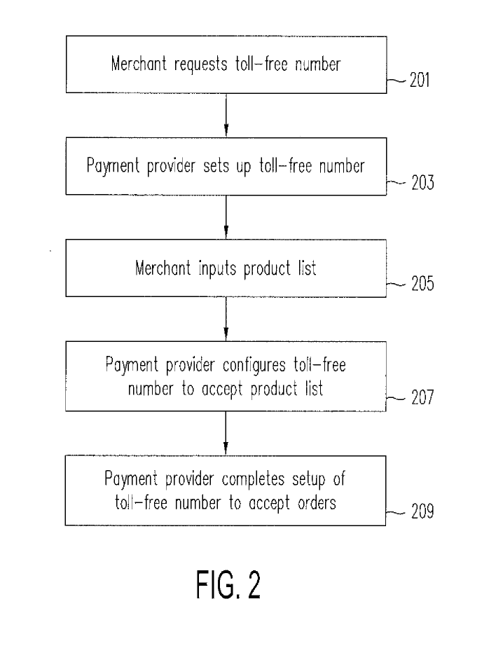

FIG. 2 shows a flow chart illustrating a method for a merchant to establish a toll-free number with a payment service provider and to configure the toll-free number to sell products identified by product codes according to one or more embodiments of the present disclosure. The payment service provider may operate the toll-free number to accept product orders, process payments, and manage product inventories for the merchant. In step 201, a merchant requests a unique toll-free number from a payment service provider. If the merchant does not already have a registered account with the payment service provider, the merchant is requested to register an account. The registered account will be linked to the merchant toll-free number and used by the payment service provider to deposit sale proceeds and to issue refunds or credits when products are returned. Merchant may also link a bank account, a credit card number, etc. to the registered account to provide a funding source for or to receive disbursements from the registered account.

In step 203, the payment service provider establishes the toll-free number for the merchant. The toll-free number operates an interactive voice response system to provide instructions to consumers and to receive inputs from consumers. The interactive voice response system may customize messages to consumers such as by generating a greeting message that includes a customer's name. Customers may provide input to the interactive voice response system using keypads on phones, icons on touch-screens, etc. In one or more embodiments, the interactive voice response system may have speech recognition capability such that consumers may provide input by speaking.

In step 205, the merchant inputs the list of products to be sold through the toll-free number. The merchant may provide the product list by calling the merchant toll-free number to access a merchant section of the interactive voice response system. Alternatively, the merchant may provide the product list by accessing a webpage of the payment service provider. The product list may contain for each product a product code, the name of the product, the price of the product, and if the payment service provider is configured to track the product inventory, the number of items the merchant has in stock. The payment service provider may track the product inventory as the product is sold through the toll-free number. When a product is out of stock, the payment service provider may stop accepting orders for the product through the toll-free number and may send an alert to the merchant to replenish the stock. On the other hand, when the merchant replenishes the stock for the product, the merchant may access the product list to update the number of items so that the product may be sold again through the toll-free number.

In step 207, the payment service provider configures the toll-free number to accept the product list. In one or more embodiments, the product list may be categorized by product categories to help the consumers navigate through the product list when the consumers need help in making product selection. For example, the product categories may be assigned category codes such that when the consumer enters a category code, the voice interactive response system may present to the consumer the products offered under the selected product category. In step 209, the payment service provider completes the set up of the toll-free number and stands ready to accept orders.

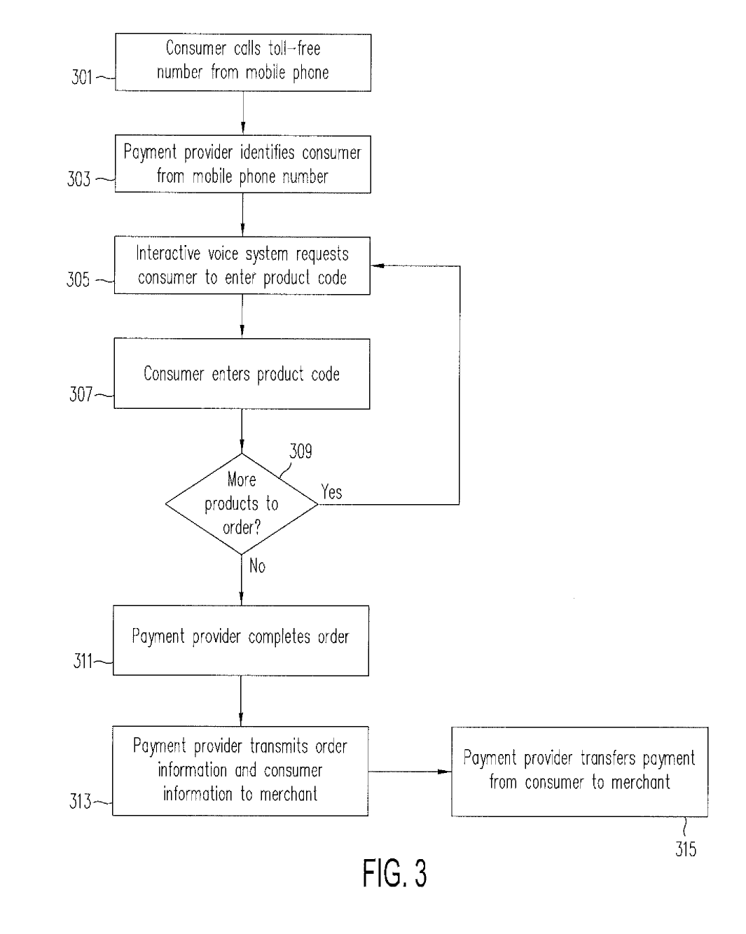

FIG. 3 shows a flow chart illustrating a method for a payment service provider to accept orders for products from a consumer over a merchant toll-free number and to process a payment according to one or more embodiments of the present disclosure. In step 301, a consumer calls the merchant toll-free number from a mobile phone associated with the consumer's registered account with the payment service provider. For example, the consumer may see an advertisement for lap-top computers from the merchant. The advertisement may have the merchant toll-free number, the price of the lap-top computers, and the product codes corresponding to the lap-top computers. The consumer is interested in purchasing a lap-top computer and calls the merchant toll-free number using the consumer's registered mobile device.

In step 303, the payment service provider obtains the unique identifier of the calling device such as the phone number or the IP address of the consumer's registered mobile device. Using the unique identifier, the payment service provider identifies the customer and the registered account associated with the mobile device. If the payment service provider is unable to associate the mobile device with a registered account, either because the customer does not have a registered account or the customer's registered account is associated with a different mobile device, the interactive voice response system may advise the customer that the customer cannot be identified. The customer may be asked to call back from a mobile device associated with a registered account. In one or more embodiments, the payment service provider may allow the customer to complete the purchase order on the condition that the order will be fulfilled only if the customer registers an account tied to the mobile device. In step 305, the interactive voice system generates a greeting message from the merchant to include the customer's name and requesting the customer to enter a product order. In one or more embodiments, if the customer does not know the product code, the customer may query the interactive voice response system for assistance in locating the product code. For example, if the products are organized by categories, the interactive voice response system may present the customer with a menu of category codes corresponding to the product categories. The customer may enter a category code to obtain information including the product codes for products under the selected category or may be presented with additional sub-category codes to select. For example, if the customer is interested in buying a lap-top computer but does not know the associated product code, the customer may enter a category code for lap-top computers to listen to a description of the selection of the lap-top computers, their prices, and the corresponding product codes.

In step 307, the consumer enters into the mobile device the product code for the product to purchase. For example, the customer may enter the product code for the lap-top computer. The customer may enter the product code using keypads, icons on touch-screen, voice commands, etc. In one or more embodiments, if the interactive voice response system has speech recognition capability, the customer may select the product by providing a description of the product using voice. The payment service provider determines if the product code is valid. If it is, the payment service provider may prompt the customer to enter the quantity of items to purchase. After the customer enters the quantity, the payment service provider may determine if the requested quantity of the product is available from the merchant. If the merchant has in stock the requested quantity of the product, the interactive voice response system may generate a message asking the customer to confirm the quantity and the product. The payment service provider may place the quantity of the product into an electronic shopping cart. Otherwise if the requested quantity is out of stock, the interactive voice response system may provide the number of the product in stock and may ask the customer to select a different quantity.

In step 309, the voice interactive response system asks the customer if there are more products to purchase. If the customer desires to purchase more product, steps 305 and 307 are repeated and the selected quantity of the additional product is added to the shopping cart. When the customer indicates that there are no more products to purchase, the interactive voice response system may request the customer to confirm the product code, the quantity, and the price for each product in the shopping cart. The interactive voice response system may request the customer to select a shipping method. The payment service provider may calculate the total purchase price including the shipping charge and the taxes. In step 311, the interactive voice response system presents the total purchase price to the customer and asks the customer to confirm the purchase. The payment service provider also through the voice response system asks the customer to authorize a payment for the total purchase price from the customer's registered account to the merchant. When the customer confirms the purchase order and the payment transaction, the voice response system may thank the customer for the purchase and may end the call. To track the product inventory, the payment service provider may subtract the quantities of the purchased products from the number of items for the products in stock.

In step 313, the payment service provider transmits the order information including the product code, the quantity, and the price for each product purchased, the shipping method, and the total purchase price to the merchant. The payment service provider also transmits information of the customer such as the customer's name and the shipping address to the merchant for the merchant to fulfill the order. In step 315, the payment service provider transfers the payment for the total purchase price from the customer's registered account to the merchant's account to complete the payment transaction.

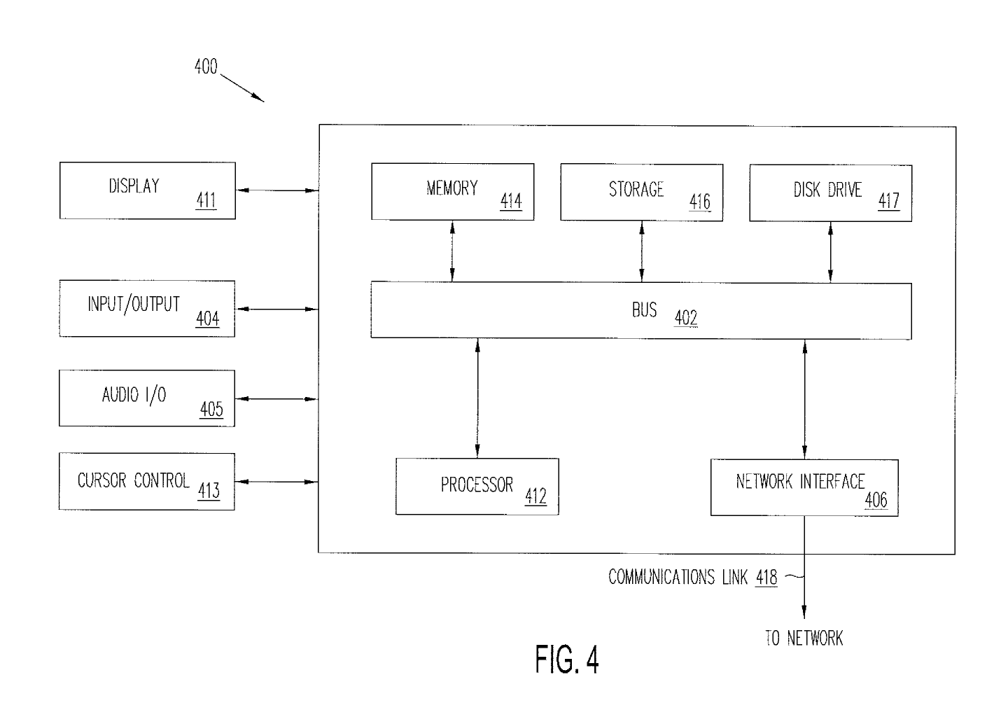

FIG. 4 is a block diagram of a computer system 400 suitable for implementing one or more embodiments of the present disclosure. In various implementations, the mobile device of the user may comprise a personal computing device (e.g., smart phone, a computing tablet, a personal computer, laptop, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows. It should also be appreciated that the toll-free number and the services to accept orders, manage inventories, and process payments may be implemented as applications running on computer system 400.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component such as a display 411, and an input control such as a cursor control 413 (such as a keyboard, keypad, mouse, etc.). An optional audio input/output component 405 may also be included to allow a user to use voice for inputting information by converting audio signals into information signals. Audio I/O component 405 may allow the user to hear audio. A transceiver or network interface 406 transmits and receives signals between computer system 400 and other devices, such as another user device, a merchant server, or a payment provider server via a communication link 418 to a network. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical, or magnetic disks, or solid-state drives, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Application software in accordance with the present disclosure, such as computer programs executed by a processor of the payment service provider to administer the toll-free number and the services to accept orders, manage inventories, and process payments, may be stored on one or more computer readable mediums. It is also contemplated that the application software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Although embodiments of the present disclosure have been described, these embodiments illustrate but do not limit the disclosure. For example, even though a system is described to provide a merchant toll-free number using an interactive voice response system, the system may be extended to allow data communications between customers and merchant such as using text messages. Similarly, even though a method is described to accept orders and process payments from customers with registered account, the method may be extended to accept orders from customers without a registered account or to process payments from credit cards, debit cards, or other types of financial instruments. It should also be understood that embodiments of the present disclosure should not be limited to these embodiments, but that numerous modifications and variations may be made by one of ordinary skill in the art in accordance with the principles of the present disclosure and be included within the spirit and scope of the present disclosure as hereinafter claimed.

We claim:

1. An apparatus of a payment service provider comprising:
one or more processors;
a memory adapted to store a plurality of machine-readable instructions wherein the memory is executed by the one or more processors to:
receive a call from a communication device of a user, wherein the user has a registered account with the payment service provider, wherein the registered account is associated with the communication device, and wherein the call is to a number associated with a merchant to sell one or more products;
identify the user and the registered account from an identifier of the communication device, wherein the identifier is received as a part of the call;
accept an order for one or more ordered products from the communication device;
transfer a payment for the order from the registered account to an account of the merchant without requiring the user to identify a payment source; and
transmit a message to the merchant for the merchant to fulfill the order.

2. The apparatus of claim 1, wherein in the call the payment service provider interacts with the communication device using an interactive voice response system.

3. The apparatus of claim 1, wherein the one or more ordered products are ordered using a product code corresponding to each of the ordered products and a quantity for each of the ordered products.

4. The apparatus of claim 1, wherein the payment service provider keeps track of an inventory for the one or more products for sale by the merchant.

5. The apparatus of claim 4, wherein an ordered product is rejected if a requested quantity for the ordered product exceeds a number of the ordered products in the inventory.

6. The apparatus of claim 1, wherein to accept an order for the one or more ordered products the payment service provider verifies the ordered products against a product catalogue, wherein the product catalogue contains a product code and a price for each of the one or more products for sale by the merchant.

7. The apparatus of claim 1, wherein the message to the merchant comprises a product code and a quantity for each of the ordered products, and information on the user.

8. The apparatus of claim 1, further comprising to transmit a personalized message to the communication device for the user when the user is identified.

9. The apparatus of claim 1, wherein the number associated with the merchant is a toll-free number.

10. A method of selling products by a payment service provider for a merchant, comprising:
receiving by a processor of the payment service provider a call from a communication device of a user, wherein the user has a registered account with the payment service provider, wherein the registered account is associated with the communication device, and wherein the call is to a number associated with a merchant to sell one or more products;
identifying by the processor the user and the registered account from an identifier of the communication device, wherein the identifier is received as a part of the call;
accepting by the processor an order for one or more ordered products from the communication device;
transferring by the processor a payment for the order from the registered account to an account of the merchant without requiring the user to identify a payment source; and
transmitting by the processor a message to the merchant for the merchant to fulfill the order.

11. The method of claim 10, further comprising interacting by the processor with the communication device in the call using an interactive voice response system.

12. The method of claim 10, wherein said accepting by the processor an order for one or more ordered products comprises accepting a product code corresponding to each of the ordered products and a quantity for each of the ordered products.

13. The method of claim 10, further comprising keeping track by the processor an inventory for the one or more products for sale by the merchant.

14. The method of claim 13, further comprising rejecting by the processor an ordered product if a requested quantity for the ordered product exceeds a number of the ordered products in the inventory.

15. The method of claim 10, wherein said accepting by the processor an order for one or more ordered products comprises verifying by the processor the ordered products against a product catalogue, wherein the product catalogue contains a product code and a price for each of the one or more products for sale by the merchant.

16. The method of claim 10, wherein the message to the merchant comprises a product code and a quantity for each of the ordered products, and information on the user.

17. The method of claim 10, further comprising transmitting by the processor a personalized message to the communication device for the user when the user is identified.

18. The method of claim 10, wherein the number associated with the merchant is a toll-free number.

19. The method of claim 10, further comprising providing by the processor information on the one or more products for sale by the merchant to the communication device.

20. A non-transitory computer readable medium adapted to store a plurality of machine readable instructions which when executed by one or more processors of a device are adapted to cause the device to perform a method, the method comprising:
receiving a call from a communication device of a user, wherein the user has a registered account with the payment service provider, wherein the registered account is associated with the communication device, and wherein the call is to a number associated with a merchant to sell one or more products;
identifying the user and the registered account from an identifier of the communication device, wherein the identifier is received as a part of the call;
accepting an order for one or more ordered products from the communication device;
transferring a payment for the order from the registered account to an account of the merchant without requiring the user to identify a payment source; and
transmitting a message to the merchant for the merchant to fulfill the order.
